(19) United States
(12) Patent Application Publication
(10) Pub. No.: US 2024/0211794 A1
(43) Pub. Date: Jun. 27, 2024

(54) PROVIDING TRAINED REINFORCEMENT LEARNING SYSTEMS

(71) Applicants: INTERNATIONAL BUSINESS MACHINES CORPORATION, ARMONK, NY (US); MASSACHUSETTS INSTITUTE OF TECHNOLOGY, Cambridge, MA (US)

(72) Inventors: Lam Minh Nguyen, Ossining, NY (US); Wang Zhang, Cambridge, MA (US); Subhro Das, Cambridge, MA (US); Alexandre Megretski, Acton, MA (US); Luca Daniel, Cambridge, MA (US)

(21) Appl. No.: 18/079,123

(22) Filed: Dec. 12, 2022

(51) Int. Cl. G06N 20/00

(52) U.S. Cl. CPC G06N 20/00

(57) ABSTRACT

Providing a trained reinforcement learning (RL) model by formulating a decision process problem for the RL model, defining at least one of a logarithmic loss function for the RL model and defining an initiation point for the RL model according to an optimized spectral norm of the RL model, training the system according to the logarithmic loss function or from the initiation point, and providing the trained RL model.

### STATEMENT REGARDING PRIOR DISCLOSURES BY THE INVENTOR OR A JOINT INVENTOR

The following disclosure is submitted under 35 USC § 102(b)(1)(A): On the Fast Convergence of Unstable Reinforcement Learning Problems; Lam Minh Nguyen, Wang Zhang, Subhro Das, Alexandre Megretski, Daniel Luca, May 28, 2022.

### FIELD OF THE INVENTION

The disclosure relates generally to providing trained reinforcement learning systems. The invention relates particularly to achieving rapid policy convergence for unstable reinforcement learning problems.

### BACKGROUND

Reinforcement learning (RL), powered by the generalization ability of machine learning structures, has been successful in classical control. RL aims to train a policy to achieve maximum reward or minimize a cost, similar to theoretical approaches to designing a controller. RL can learn an optimal policy from the past data directly by solving an optimization problem without the knowledge of the underlying dynamics, or requiring such dynamics to be inherently stable, which differs from classical optimal control, which requires full knowledge of transition dynamics.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable training reinforcement learning models for unstable systems.

Aspects of the invention disclose methods, systems and computer readable media associated with training a reinforcement learning (RL) system by formulating a decision process problem for the RL model, defining at least one of a logarithmic loss function for the RL model and defining an initiation point for the RL model according to an optimized spectral norm of the RL model, training the system according to the logarithmic loss function or from the initiation point, and providing the trained RL model.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a computing environment, according to an embodiment of the invention.

FIG. 2 provides a flowchart depicting an operational sequence, according to an embodiment of the invention.

FIG. 3 depicts a cloud computing environment, according to an embodiment of the invention.

FIG. 4 depicts abstraction model layers, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

For many reinforcement learning applications, the system is assumed to be inherently stable and with bounded rewards, states, and action spaces. These are key requirements for the optimization convergence of classical reinforcement learning reward functions with discount factors. Unfortunately, these assumptions do not hold true for many real-world problems such as an unstable linear-quadratic regulator (LQR), considered herein as and LQR having a matrix with a spectral norm outside the unit circle. This disclosure provides new methods to stabilize the convergence of unstable reinforcement learning problems with policy gradient methods.

Aspects of the present invention relate generally to training unstable reinforcement learning systems and, more particularly, to training unstable reinforcement learning systems. In embodiments, methods formulate a decision process problem for the RL model, define a loss function for the system including a logarithmic term, and/or define an initiation point for the training according to a system spectral radius absolute value of less than 1, train the system according to the loss function and/or the starting at the defined initiation point, and provide the trained system for use through a system user interface or through actual use of the system for device control, such as controlling an aerial vehicle.

In accordance with aspects of the invention there is a method for automatically training an unstable reinforcement learning system, the method causing a computer system to formulate a decision process problem for the RL model, define a loss function for the system including a logarithmic term, and/or define an initiation point for the training according to a system spectral radius absolute value of less than 1, train the system according to the loss function and/or the starting at the defined initiation point, and provide the trained system for use. In this manner the method enables the training of an otherwise unstable and unbounded RL model.

Aspects of the invention provide an improvement in the technical field of RL models. Conventional (stable) RL model optimization may rely upon critical assumption of stable system dynamics. In many cases, RL model parameters must be artificially clipped to enable optimization to proceed. As a result, conventional optimization convergence methodologies fail in optimizing unstable systems. In some cases, however, users may desire the optimization and training of an RL model for an inherently unstable system, such as an unmanned aerial vehicle. Implementations of the invention utilize disclosed methods to optimize RL models for unstable systems using a logarithmic loss function during training, initiating the training of the system at a point associated with inherent trained system stability, or both. This provides the improvement of enabling a computer system to train and provide an RL model for physical systems which lack inherent stability.

Aspects of the invention also provide an improvement to computer functionality. In particular, implementations of the invention are directed to a specific improvement to the way computer systems optimize and train RL models, embodied in the definition of a logarithmic loss function and/or the definition of an initiation point from a spectral radius absolute value magnitude of less than 1. In embodiments, the system trains the RL model using the logarithmic loss function, the defined initiation point, or both, yielding a trained RL model for inherently unstable systems. In this manner, embodiments of the invention affect system capabilities in training RL models associated with unstable systems.

As an overview, an RL model for a system is an artificial intelligence application executed on data processing hardware that trains a model to return a maximum reward or to minimize a cost. The RL model receives inputs from various sources including input over a network, such inputs may relate to the actions of an agent within a system, evaluates a loss function according to the new system state associated with the action and updates the model to reflect a change in system policy gradients due to the loss function analysis. For example, an RL model receives input regarding motion of a vehicle in a system and evaluates the potential next steps of the vehicle according to the current policy gradients and the current loss function. The trained RL model outputs a next step according to the training of the model. Training RL models for unstable systems requires methods which overcome loss functions increasing exponentially rendering convention RL training methods unusable. Disclosed methods and systems enable the training of RL models for otherwise unstable systems.

In an embodiment, one or more components of the system can employ hardware and/or software to solve problems that are highly technical in nature (e.g., formulating a decision problem for an RL model, defining a logarithmic loss function and/or a system training initiation point based upon a system spectral radius value being less than 1, training the system using the initiation point and/or the logarithmic loss function, and providing the trained model for use as a control system, etc.). These solutions are not abstract and cannot be performed as a set of mental acts by a human due to the processing capabilities needed to facilitate RL model training, for example. Further, some of the processes performed may be performed by a specialized computer for carrying out defined tasks related to training RL models. For example, a specialized computer can be employed to carry out tasks related to training RL models for unstable systems, or the like.

In an embodiment, systems and methods formulate a decision process problem for the target reinforcement learning (RL) model and underlying physical system. In this embodiment, the decision process problem includes an input-to-output stability expression having an output such as y=h(x(t)), where, for example, y may be a quadratic function to regulate the error or other system properties targeted for stabilization. Input-to-output stability for such a system requires that there exist K function γ(·): R⁺→R⁺ and KL function β(·, ·): R⁺×R⁺→R⁺, such that ∥y(x(t, x₀, u))∥≤≡(∥u∥_{∞})+β(∥x₀∥, t).

Input-to-output stability indicates bounded inputs yielding bounded system behavior, without a causal relationship between the two considering an arbitrarily chosen output function y. In RL models, the agent's actions always return a cost-to-go, but not necessarily the whole trajectory, making input-to-output stability suitable for developing an RL model for a potentially unstable underlying system.

In an embodiment, in formulating the decision problem for the RL model and underlying system, methods consider a discrete-time continuous Markov decision proves (S, A, P, C) where S is the continuous state space, A is the continuous action space, P(s_{t+1|}sₜ, a) is the transition probability, cₜ(s, a) is the immediate cost at time step t and s₀ is the initial condition. The cost may be assumed to be upper bounded by a polynomial of time step t, such that |cₜ(s, a)|≤DC^{t}, where D>0, and C>0. Methods and systems seek a policy definition to decrease accumulated costs. For unstable systems, the RL model cost can grow exponentially against time step t. Disclosed methods alter the RL loss function, including a logarithmic term log(Σₜ₌₀^{T} cos t(xₜ, aₜ)), to effectively decease the condition number of the underlying system, such that the loss function becomes

$$estimated loss = \frac{1}{m} {\sum }_{i = 1}^{m} log ( {\sum }_{t = 0}^{T} cost ( {x}_{t} , {a}_{t} ) ) ,$$

and the model parameter is updated by θ←θ−η∇loss. Inclusion of the logarithmic terms yields a model of the system which can be modeled using RL as the estimated loss per time step now grows linearly rather than exponentially.

In an embodiment, systems and methods define an initiation point for the RL model training according to a spectral radius (largest absolute value of system eigenvalues) value for the point. Without being bound by theory, methods assume that initiating RL training at a point having a spectral radius value of less than 1 yields a stable RL model of the underlying system. Methods utilize pre-processing to evaluate system spectral radii and identify an initiation point having an spectral radius value of less than 1. In this embodiment, system/methods regulate only the system spectral radius rather than the estimated cost loss function.

As an example of logic used in defining such an initiation point:

```
Input: system state transition function f and policy θ, finite time step T,
batch size b, Initialize θ
for 1 = 1 to N do
  Sample {x₀¹ ... x₀ⁱ ... x₀^{b}}
  Loss ← 0
  for i = 1 to b parallel do
    for t = 0 to T do
      xₜⁱ⁺¹ ← f (xₜⁱ, θ)
    end for
    $Loss ← Loss + max ( \frac{‖ {x}_{t}^{i} ‖}{‖ {x}_{T - 1}^{i} ‖} - 1 , 0 )$
  end for
  Loss ← Loss/b
  Update parameters: θ ← θ − ηVθ Loss
end for
```

In an embodiment, after defining the logarithmic loss function, methods train the RL model using system data, yielding a trained RL model for the underlying system. Methods then provide access to the trained model for use in controlling the underlying system, such as for control over the actions of an unmanned aerial vehicle. In this embodiment, methods display outputs from the model during use as a controller for the system enabling a user to monitor the performance of the model as the controller.

In an embodiment, after defining the initiation point, methods train the RL model using system data, yielding a trained RL model for the underlying system. Methods then provide access to the trained model for use in controlling the underlying system, such as for control over the actions of an unmanned aerial vehicle. In this embodiment, methods display outputs from the model during use as a controller for the system enabling a user to monitor the performance of the model as the controller.

In an embodiment, after defining the logarithmic loss function and the initiation point, methods train the RL model using system data, yielding a trained RL model for the underlying system. Methods then provide access to the trained model for use in controlling the underlying system, such as for control over the actions of an unmanned aerial vehicle. In this embodiment, methods display outputs from the model during use as a controller for the system enabling a user to monitor the performance of the model as the controller.

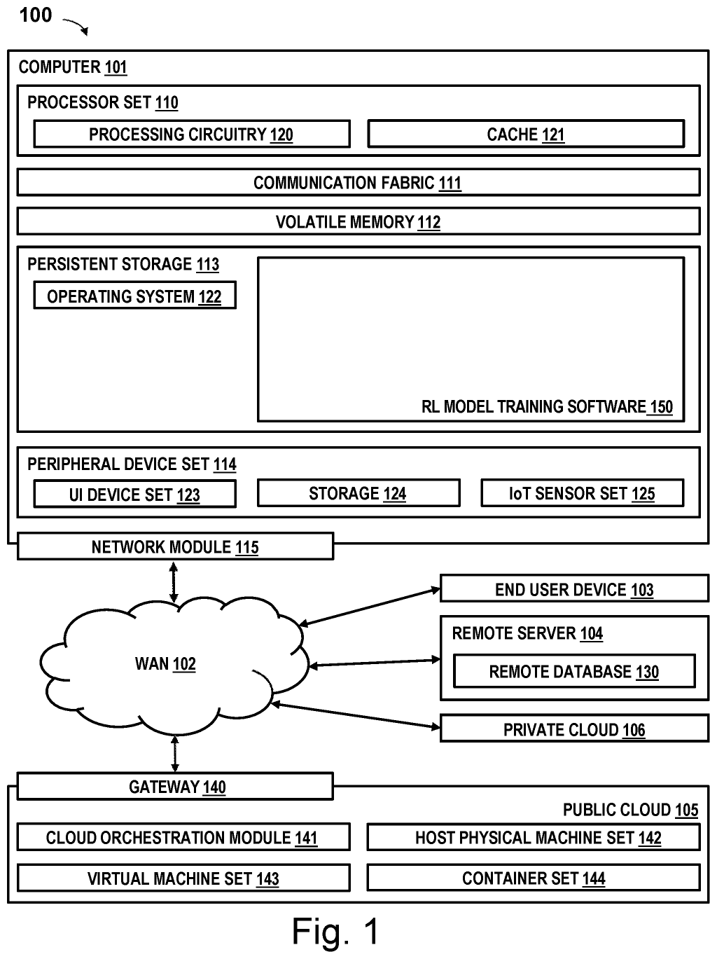

As shown in FIG. 1, computing environment 100 contains an example of an environment for the execution of at least some of the computer code involved in performing the inventive methods, such as RL model training methods software 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive RL model training methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. however, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

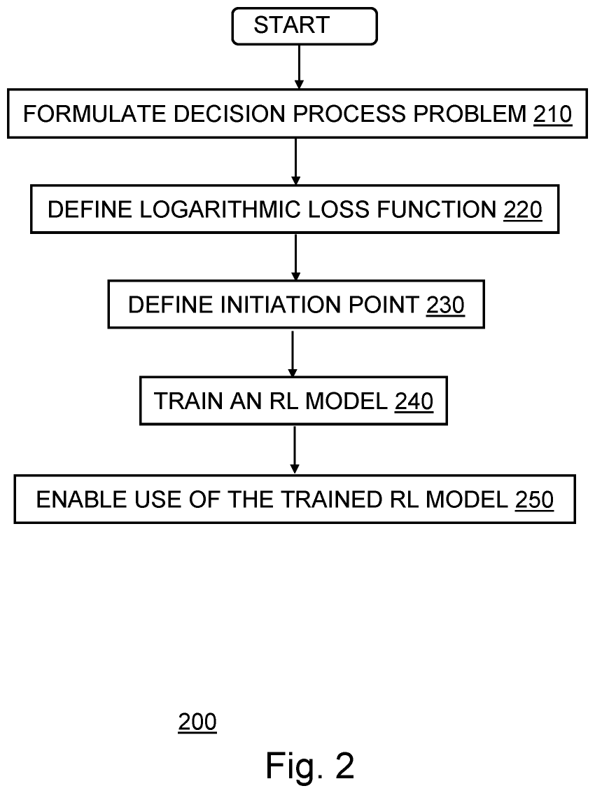

FIG. 2 provides a flowchart 200, illustrating exemplary activities associated with the practice of the disclosure. After program start, at block 210, systems and methods of software 150 formulate a decision process problem for the target RL model. The decision process problem may include a conventional loss function for the RL model.

At block 220, systems and methods define a logarithmic loss function for use in place of the conventional loss function in training the RL model. The logarithmic loss function enables the training to occur in regions of actions where the process problem and underlying system may have instabilities which would otherwise lead to exponential growth in system state changes with agent actions.

At block 230, systems and methods define a training initiation point for the training epochs. The systems and methods evaluate the system spectral radius and identify an initiation point having a system spectral radius maximum absolute value magnitude less than 1. Such an initiation point constitutes a necessary and sufficient condition for stability of the system during training.

At block 240 the systems and methods train the RL model using at least one if not both of the defined logarithmic loss function and the defined initiation point. Such uses enable successful training of RL models for inherently unstable underlying systems.

At block 250 systems and methods enable the use of the trained model in controlling elements acting within the target underlying systems in spite of the inherent instabilities of such elements acting in those systems. Systems and methods provide access to the outputs and inputs of the trained models enabling the use of the models for control purposes, such as real-time control for unstable drones. In an embodiment, methods train the RL model using data associated with vehicle operations. After training the model, methods embed the trained RL model as part of the overall control system of the vehicle such that the motion of the vehicle remains stable by following the outputs of the trained RL model for controlling the vehicle in view of real-time inputs from vehicle sensors.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (Saas): the capability provided to the consumer is to use the provider's applications running on a cloud infrastructure. The applications are accessible from various client devices through a thin client interface such as a web browser (e.g., web-based e -mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

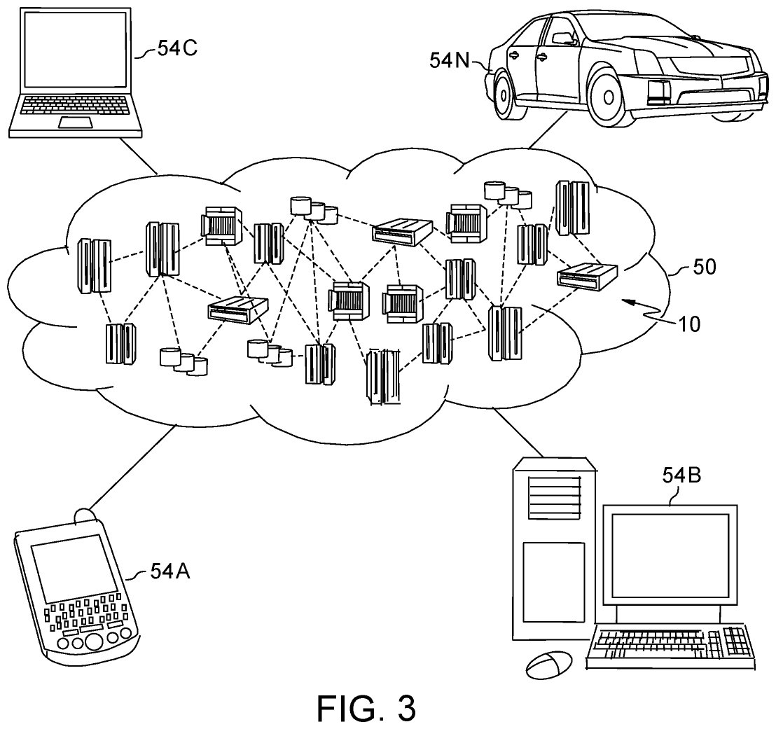

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

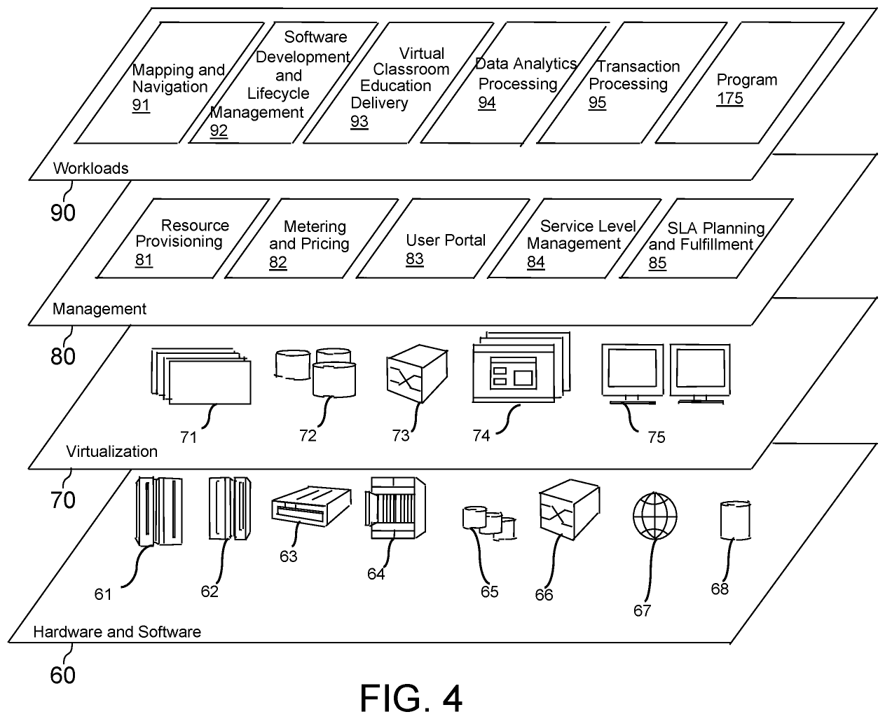

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and RL model training program 175.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for training a reinforcement learning (RL) system, the method comprising:
formulating, by one or more computer processors, a decision process problem for the RL model;
defining, by the one or more computer processors, at least one of a logarithmic loss function for the RL model and defining an initiation point for the RL model according to an optimized spectral norm of the RL model;
training, by the one or more computer processors, the system according to the logarithmic loss function or from the initiation point; and
providing, by the one or more computer processors, the trained RL model.

2. The computer implemented method according to claim 1, further comprising:
defining, by the one or more computer processors, a logarithmic loss function for the RL model;
training, by the one or more computer processors, the system according to the logarithmic loss function; and
providing, by the one or more computer processors, the trained RL model.

3. The computer implemented method according to claim 1, further comprising:
defining, by the one or more computer processors, an initiation point for the RL model according to the optimized spectral norm; and
training, by the one or more computer processors, the RL model from the initiation point.

4. The computer implemented method according to claim 3, wherein defining the initiation point comprises regulating a system spectral radius.

5. The computer implemented method according to claim 4, wherein defining the initiation point comprises defining an initiation point wherein a magnitude of an absolute value of the system spectral radius is less than 1.

6. The computer implemented method according to claim 1, further comprising:
formulating, by the one or more computer processors, a decision process problem for the RL model;
defining, by the one or more computer processors, a logarithmic loss function for the RL model and an initiation point for the RL model according to an optimized spectral norm of the RL model;
training, by the one or more computer processors, the system from the initiation point and according to the logarithmic loss function; and
providing, by the one or more computer processors, the trained RL model.

7. The computer implemented method according to claim 6, further comprising defining, by the one or more computer processors, the initiation point according to a system spectral radius magnitude of less than 1.

8. A computer program product for providing trained reinforcement learning systems, the computer program product comprising one or more computer readable storage media and collectively stored program instructions on the one or more computer readable storage media, the stored program instructions which, when executed, cause one or more computer systems to:
formulate a decision process problem for the RL model;
define at least one of a logarithmic loss function for the RL model and defining an initiation point for the RL model according to an optimized spectral norm of the RL model;
train the system according to the logarithmic loss function or from the initiation point; and
provide the trained RL model.

9. The computer program product according to claim 8, the stored program instructions further comprising program instructions to:
define a logarithmic loss function for the RL model;
train the system according to the logarithmic loss function; and
provide the trained RL model.

10. The computer program product according to claim 8, the stored program instructions further comprising program instructions to:
define an initiation point for the RL model according to the optimized spectral norm; and
train the RL model from the initiation point.

11. The computer program product according to claim 10, wherein defining the initiation point comprises regulating a system spectral radius.

12. The computer program product according to claim 11, wherein defining the initiation point comprises defining an initiation point wherein a magnitude of an absolute value of the system spectral radius is less than 1.

13. The computer program product according to claim 8, the stored program instructions further comprising program instructions to:
formulate a decision process problem for the RL model;
define a logarithmic loss function for the RL model and an initiation point for the RL model according to an optimized spectral norm of the RL model;
train the system from the initiation point and according to the logarithmic loss function; and
provide the trained RL model.

14. The computer program product according to claim 13, further comprising defining the initiation point according to a system spectral radius magnitude of less than 1.

15. A computer system for providing a trained reinforcement learning system, the computer system comprising:
one or more computer processors;
one or more computer readable storage devices; and
stored program instructions on the one or more computer readable storage devices for execution by the one or more computer processors, the stored program instructions which, when executed, cause the one or more computer processors to:
formulate a decision process problem for the RL model;
define at least one of a logarithmic loss function for the RL model and defining an initiation point for the RL model according to an optimized spectral norm of the RL model;
train the system according to the logarithmic loss function or from the initiation point; and
provide the trained RL model.

16. The computer system according to claim 15, the stored program instructions further comprising program instructions to:
define a logarithmic loss function for the RL model;
train the system according to the logarithmic loss function; and
provide the trained RL model.

17. The computer system according to claim 15, the stored program instructions further comprising program instructions to:
define an initiation point for the RL model according to the optimized spectral norm; and
train the RL model from the initiation point.

18. The computer system according to claim 17, wherein defining the initiation point comprises regulating a system spectral radius.

19. The computer system according to claim 18, wherein defining the initiation point comprises defining an initiation point wherein a magnitude of an absolute value of the system spectral radius is less than 1.

20. The computer system according to claim 15, the stored program instructions further comprising program instructions to:
formulate a decision process problem for the RL model;
define a logarithmic loss function for the RL model and an initiation point for the RL model according to an optimized spectral norm of the RL model;
train the system from the initiation point and according to the logarithmic loss function; and
provide the trained RL model.
